(19) United States
(12) Patent Application Publication
(10) Pub. No.: US 2011/0272537 A1
(43) Pub. Date: Nov. 10, 2011

(54) ENGAGEMENT ARRANGEMENT

(76) Inventors: Nabil Gindy, Nottingham (GB); Amir Fahmi, Nottingham (GB); Yan Wang, Nottingham (GB); Venkata S. Kancharla, Nottingham (GB); Kevin Walker, Nottingham (GB)

(21) Appl. No.: 12/736,317

(22) PCT Filed: Apr. 2, 2009
(86) PCT No.: PCT/GB2009/000877

§ 371 Date: Apr. 5, 2011

(30) Foreign Application Priority Data
Apr. 3, 2008 (GB) 0806063.4
Mar. 16, 2009 (GB) 0904436.3

(51) Int. Cl. H01F 7/02; F16M 13/00; H01F 7/00; H01F 1/28

(52) U.S. Cl. 248/201; 252/62.54; 248/309.4

(57) ABSTRACT

Retention of position and clamping of components is ideally performed with an engagement arrangement which is reconfigurable. Magnetorheological (MR) fluids have been utilised for reconfigurable engagement arrangements but typically require powerful electromagnets to activate the MR fluid. By providing enclosed chambers with a constriction in the form of a passage between a reservoir portion of the chamber and an engagement portion of the chamber it is possible to utilise smaller permanent magnets acting upon a smaller volume of MR fluid in the passage. In such circumstances initial positioning of engagement elements is provided through forced displacement in the form of a plunger or pin and then retention of the engagement element position achieved through positioning a magnetic field across and about a passage to create an effective block retaining MR fluid volume and therefore presentation of the engagement element. In order to achieve such performance MR fluids which have an appropriate performance and durability are necessary. In such circumstances in accordance with other aspects of the present invention particular magnetorheological fluids are also described.

The present invention relates to profile engagement arrangements and more particularly to engagement arrangements utilised to hold or retain components of a regular or irregular shape.

It will be understood in a wide range of engineering and other environments it is desirable to hold or retain a component such as an aerofoil to allow machining and other processes. Such components may be regular or irregularly shaped but in any event it is desirable to ensure correct location and positioning. It will be understood that the component must be accurately retained and positioned in such assemblies but without damage to the component itself and ensuring the machining or other forming processes do not stimulate vibration or other movements which in themselves could result in erroneous processing of the component. It will also be understood in some circumstances components may be held within an arrangement such as a vice to allow not only machining but also assembly of other components to the retained component.

In the above circumstances it will be understood that provision of appropriate profile engagements for simple presentation as well as holding and clamping create a number of problems.

As indicated above generally profile engagement arrangements whether they be simply for presentation or machining will typically hold a work piece or component for inspection or machining operations. Nearly all manufacturing processes require machining as well as assembly stages. Unfortunately with such engagement arrangements there is a compromise which means that the engagement arrangement is not optimised for particular conditions. In such circumstances the engagement arrangement may be standardised resulting in potential problems with regard to accurate presentation and subsequent problems with regard to machining processes. A range of flexible fixtures of a modular type are known. These modular fixture and engagement arrangements include V blocks, toggle clamps, locating clamps and similar arrangements. Although modular in nature it will be understood that there is a limitation to standard geometric shapes and use of such arrangements is time consuming both in reconfiguring and adjusting to and from the standard shapes. Additionally it will be understood with regard to fixtures and clamping arrangements a force will be applied such that if the component or work piece is not accurately presented or retained such large clamping forces will be applied disproportionately so potentially damaging the component. Such problems are particularly present with regard to components which have curved surfaces or irregular shapes such as turbine blades and aerofoils.

Ideally an engagement arrangement should have a variable or reconfigurable modular structure to accommodate difficult types, shapes and sizes of component. It is known to provide conformable fixtures comprising encapsulated or mechanical devices. For example encapsulated fixtures can be found in various industries including the aerospace industry where low melting point molten matrix materials such as lead or zinc are used to enclose irregular shaped components such as turbine blades and so produce well defined surfaces for part location and clamping during machining operations or assembly. Whilst such approaches may be acceptable it will be understood that the temperature changes as a result of transition from a liquid to solid state by the matrix can induce thermal stresses and it is possible that machining processes may still cause deformation damage to a work piece or component. A further factor is that low melting point alloys generally include harmful elements such as lead which may create unacceptable operational environment issues. In such circumstances such an approach is unacceptable with regard to work pieces which are vulnerable to heating and cooling cycles which inherently will be present during the initial application and removal of the holding matrix.

More advanced engagement arrangements are known for holding and presenting irregular shaped components. These arrangements may include magneto-rheological fluids whereby the magneto-rheological fluid (MR) fluid is presented as a film or otherwise embraces an irregular shaped component in a similar fashion to prior low melting point matrix materials. It is also known as illustrated in International patent application number 2005/049278 and U.S. Pat. No. 7,204,481 to provide a clamping device which uses a number of clamping rods moveable to engage a component utilising a magneto-rheological fluid. A magnetic field is applied to the fluid which then solidifies in order to engage and typically retain or present the component. The above prior arrangements have limitations with regard to modularity, compressibility, operating conditions and the physical size of the fixture. In terms of modularity each individual arrangement is designed for a particular component and the MR fluid typically utilised to accommodate slight variations in size and shape so limiting the applicability of the arrangement. Furthermore, it will be understood that MR fluids by their nature act by solidifying such that within a system if any air is not expelled then this air may be compressed and therefore adjust the strength of engagement by the arrangement. Additional problems relate to utilisation of electrical currents which may be of a high and dangerous level which in combination with the necessity of in some circumstances to utilise water as a coolant for machining processes can result in dangerous operation. Furthermore, the MR fluid may itself be contaminated by water. It will also be understood that a particular problem may relate to the size of prior arrangements particularly where smaller components must be accommodated.

Essentially problems relate to the volume of MR fluid which must be solidified by a magnetic field. Large volumes will require utilisation of powerful magnets which may mean necessary use of electro-magnets. Furthermore, there is also the possibility of degradation over time of the MR fluid. It will be understood that the MR fluid essentially comprises magnetically inducible particles in suspension. If these particles precipitate out then the effectiveness of solidification with regard to MR fluid control is reduced.

In accordance with first aspects of the present invention there is provided an engagement arrangement for a component, the arrangement comprising a chamber to retain a volume of magneto-rheological fluid and having a displaceable engagement element, a portion of the MR displaceable through a passage in the chamber to move the engagement element, the passage comprising a narrowing of the chamber and having a magnet associated thereabout to act upon the MR fluid within the passage to retain displacement of the MR fluid within the chamber between the engagement member and the passage.

Generally, the arrangement incorporates a plurality of engagement elements. Typically, each engagement element has its own chamber. Generally, each chamber allows differential displacement of the MR fluid across the passage. Possibly each chamber and/or each of the engagement elements or members can be of different sizes.

Generally, each chamber is closed by a plunger to provide forced displacement of the MR fluid in use.

Generally, the passage comprises a constriction between an engagement end of the chamber and a reservoir end of the chamber.

Generally, the magnet is a permanent magnet.

Typically, the arrangement comprises a housing defining the chamber with an outlet to accommodate the engagement member. Typically, the outlet has an effective length to guide movement of the engagement member beyond the chamber.

Generally, the engagement element or member has a shaped end. Possibly, the shaped end is integral with an elongate member or is formed by a separable element.

Generally, the engagement element is suspended upon the MR fluid against a return bias. Possibly, the return bias is provided by a mechanical spring.

Possibly, the arrangement incorporates a sensor to determine movement of the elongate member and means to record position of the elongate member. Typically, recorded positions for each elongate member is used to provide a part profile record of a component presented in use upon the arrangement.

Possibly, ends of the elongate elements are overlaid by a membrane.

Typically, in accordance with aspects of the present invention apparatus is provided comprising a plurality of arrangements as described above. Generally, these arrangements are presented opposite each other to support and/or hold a component there between. Generally, the arrangements are presented upon a respective base. Possibly, each base is displaceable relative to each other provide further support and/or hold a component.

Generally, apparatus in accordance with aspects of the present invention may act to provide a forming surface to shape a component by pressing or other engagement.

Also in accordance with aspects of the present invention there is provided an MR fluid comprising polystyrene combined with dodecanic acid initially in chloroform with NaOH in water along with a hydrocarbon oil, the combination heated to evaporate the chloroform to define a matrix to receive carbonyl-iron or other magnetically inducible particles in suspension.

Generally, the polystyrene is presented in a form with a density preferably around 1050 Kg/m³. Generally, the hydrocarbon oil has a viscosity in the range 1 to 10,000 and preferably in the order of 75 centipoise with a density in the range 0.1 to 5 and typically preferably in the range 0.6 to 0.9 g/cm³. Typically, the carbonyl-iron particles have a size in the range from 1 to 1,000 micron and preferably 3 μm with a density in the range from 1 to 10 g/cm³ and preferably in the order of 7.9 g/cm³.

Typically, the MR fluid has a composition comprising polystyrene 0.1 to 10 wt/%, dodecanic acid 0.1 to 10 wt/%, sodium hydroxide 0.05 to 5 wt/%, hydrocarbon oil 5 to 95 wt/% and carbonyl-iron particles 20 to 90 wt/%.

Generally, the carbonyl irons are retained in suspension within the MR fluid.

Also in accordance with aspects of the present invention there is provided a method of making an MR fluid comprising combining polystyrene and dodecanic acid initially in chloroform with subsequent addition of sodium hydroxide in water whilst continuously stirring, combining the stirred combination of polystyrene, dodecanic acid and sodium hydroxide in chloroform and water suspension with a hydrocarbon oil, heating the combination to evaporate the chloroform and mixing the presented matrix with carbonyl-iron or other magnetically inducible particles.

Generally, the method includes the addition of in the order of 0.1 to 10 wt/% polystyrene, 0.1 to 10 wt/% dodecanic acid, 0.05 to 5 wt % sodium hydroxide in water, 5 to 95 wt/% hydrocarbon oil and 20 to 90 wt % carbonyl-iron particles.

Embodiments of aspects of the present invention will now be described by way of example only with reference to the accompanying drawings in which:

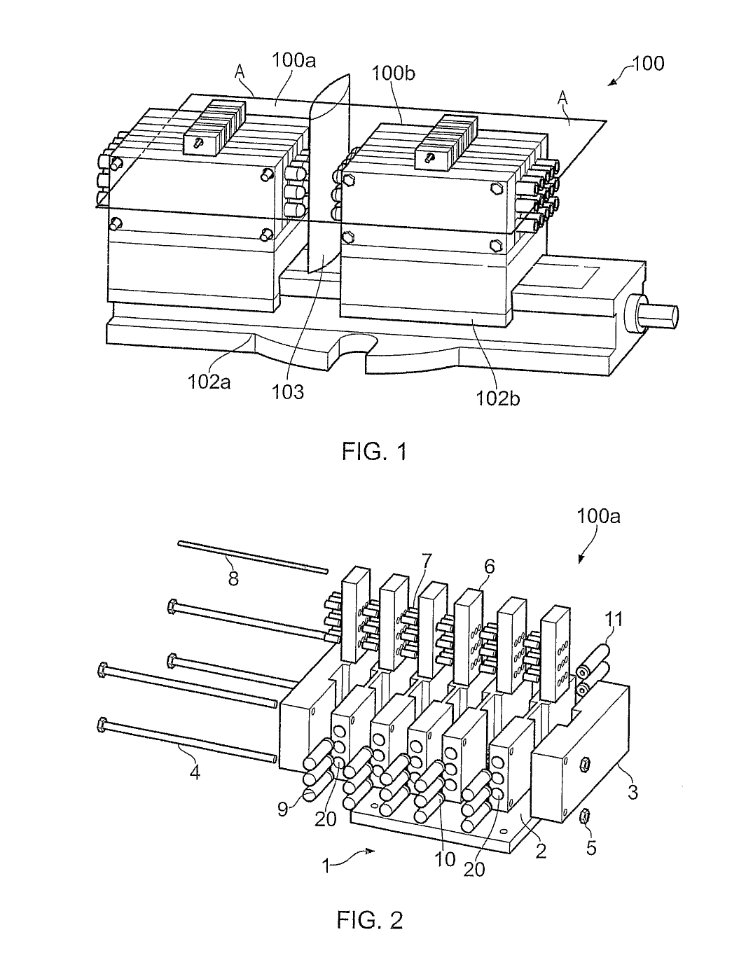

FIG. 1 is a perspective view of an engagement assembly with arrangements in accordance with aspects of the present invention;

FIG. 2 is an exploded view of an arrangement as depicted in FIG. 1;

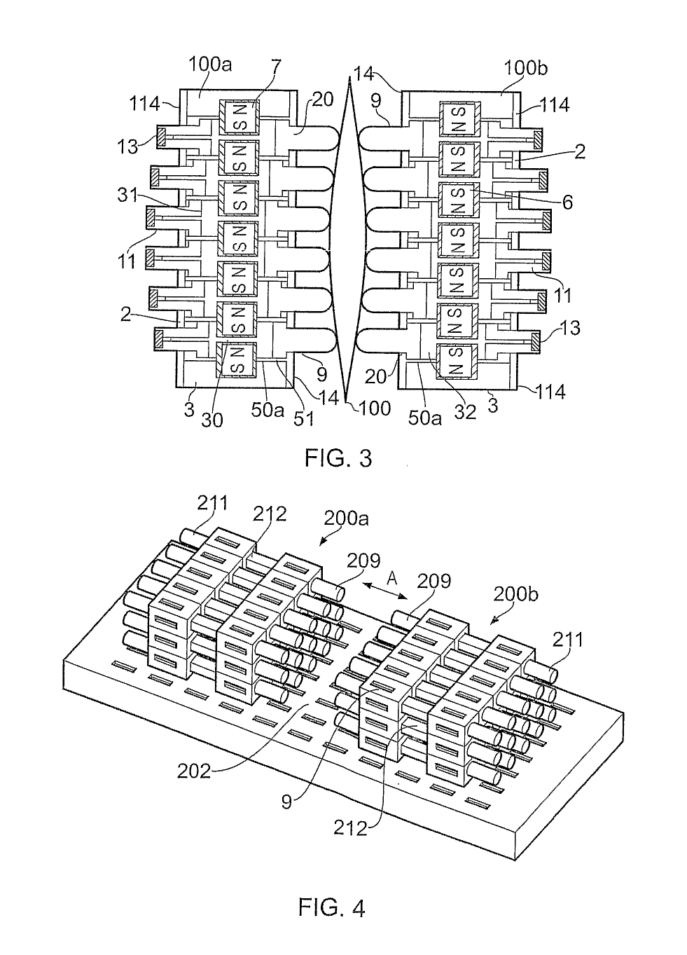

FIG. 3 is a cross section of a first embodiment of engagement arrangements in accordance with aspects of the present invention;

FIG. 4 is a perspective view of a second embodiment of an engagement assembly including arrangements in accordance with aspects of the present invention;

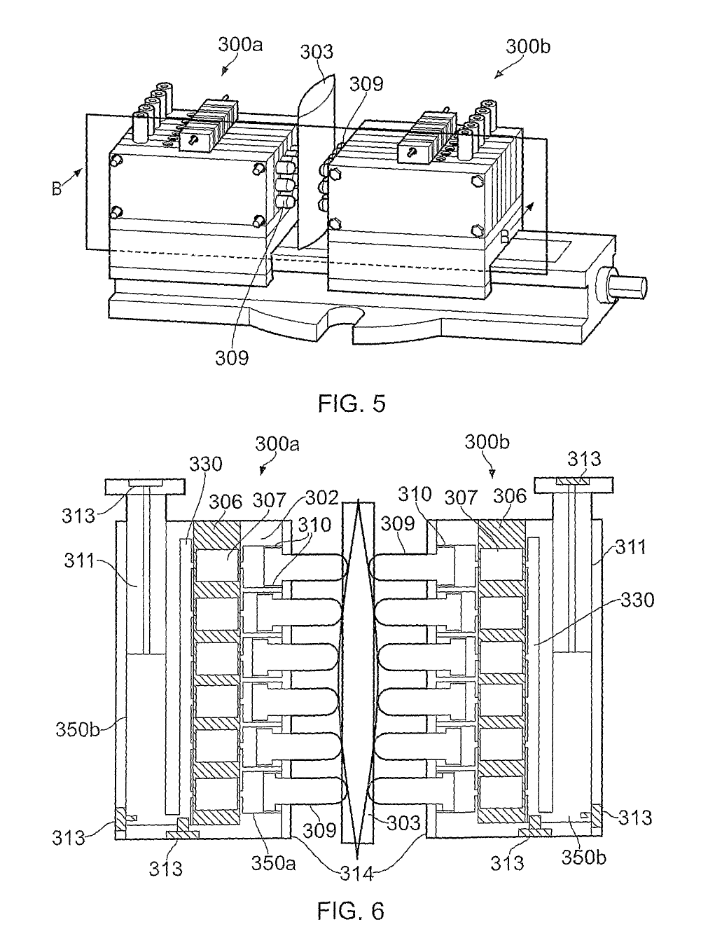

FIG. 5 is a perspective view of a third embodiment of an engagement assembly including arrangements in accordance with aspects of the present invention;

FIG. 6 is a sectional view of the third embodiment of aspects of the present invention as depicted in FIG. 5;

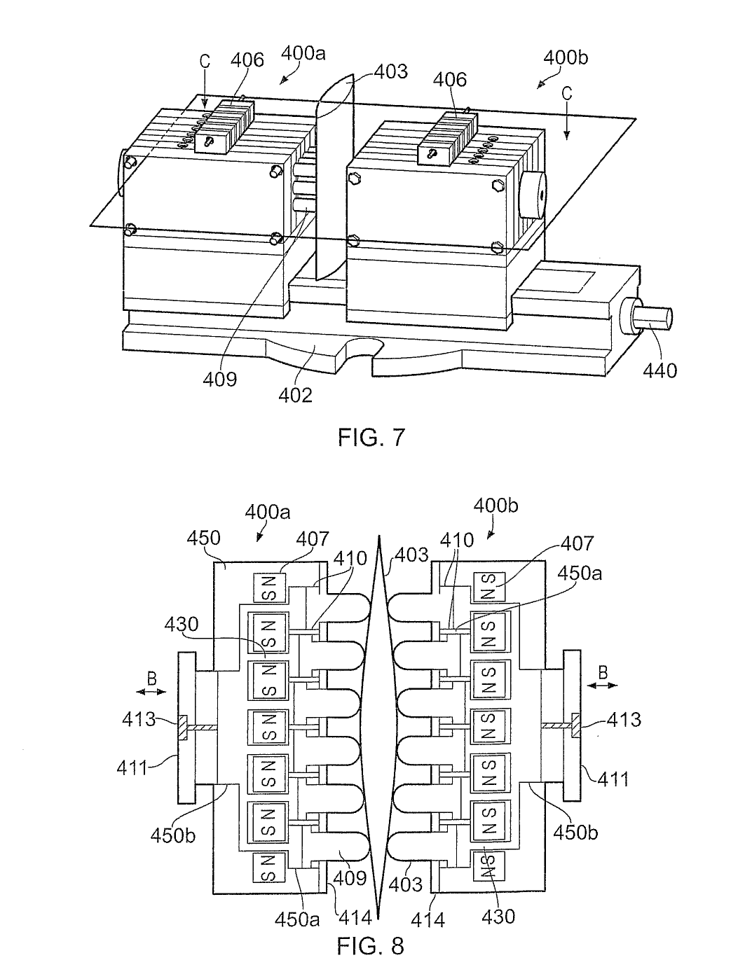

FIG. 7 is a perspective view of a fourth embodiment of an engagement assembly including arrangements in accordance with aspects of the present invention;

FIG. 8 is a cross sectional view of the fourth embodiment as depicted in FIG. 7;

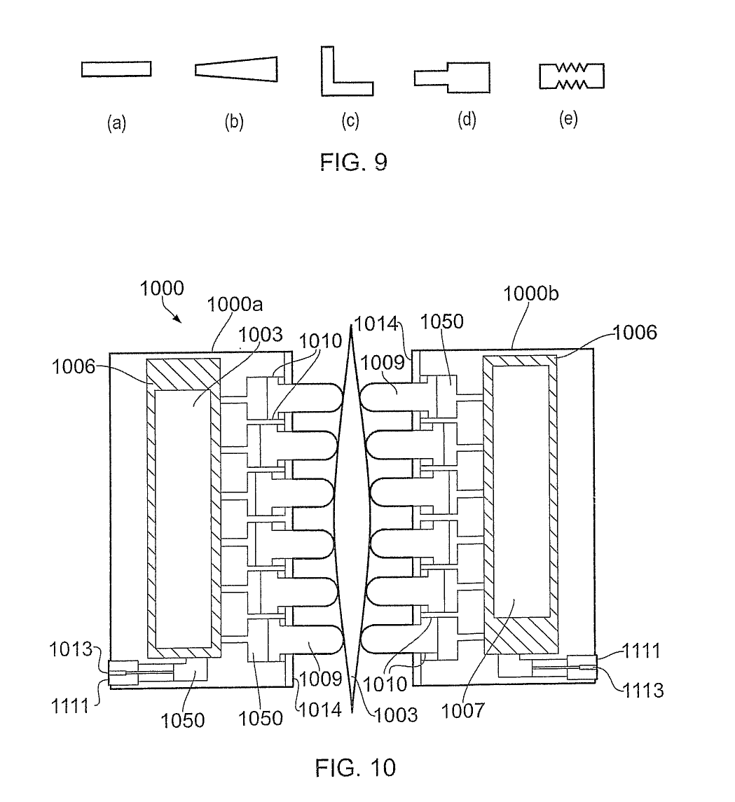

FIG. 9 illustrates alternatives with regard to passage shape for effective MR fluid operation;

FIG. 10 is a schematic side cross section of an engagement assembly including arrangements in accordance with fifth embodiments of aspects of the present invention; and,

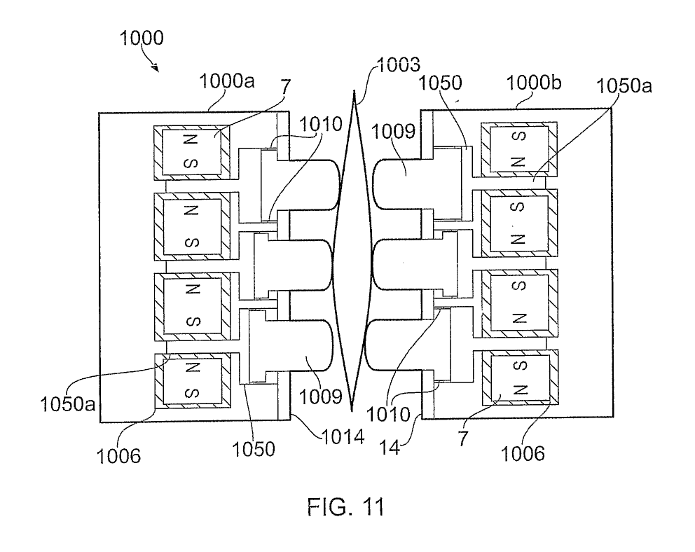

FIG. 11 is a plan view of the assembly as depicted in FIG. 10.

As indicated above provision of an engagement arrangement which allows retention and holding as well as presentation of components which can be in a number of regular or irregular forms generally requires a reconfigurable nature. In accordance with aspects of the present invention a reconfigurable nature is achieved through use of a magnetorheological fluid otherwise known and referred to as an MR fluid. Such MR fluids are well known in terms of their nature and generally comprise a suspension of magnetically inducible particles which can under the influence of a magnetic field achieve a viscosity which approaches solidity in use. In such circumstances the fluid is switchable between a fluid state and a substantially solid state. This capability is utilised in a number of environments and with regard to aspects of the present invention allows in the fluid state adjustment of the arrangement for engagement against a component and then retention of that engagement position by switching the MR fluid, or a portion of the fluid, into a solid state. It will also be understood once initial contact and retention is achieved further reinforcement of the engagement can be achieved through mechanical devices by presenting arrangements in accordance with aspects of the present invention upon mutually displaceable base segments.

FIG. 1 provides a schematic illustration in a perspective view of a first embodiment of an engagement assembly 100 in accordance with aspects of the present invention. The assembly 100 comprises two arrangements 100a, 100b in an opposed relationship with a component 103 between them. The arrangements 100a, 100b are presented upon respective base sections 102 which may be moved relative to each other in order to accommodate the shape of the component 103 initially and also provide greater retention force for the arrangement 100 in use. In essence the arrangements 100a, 100b comprise clamp blocks to engage the component 103 to allow assembly or subsequent machining of the component 103. As illustrated the component 103 is an aerofoil or blade but it will be understood that other components could be accommodated.

FIG. 2 provides a schematic illustration in a perspective view of one arrangement 100a. The depiction in FIG. 2 is an exploded view in which the arrangement 100a is shown with a housing comprising a base block 1 associated with middle blocks 2 and side blocks 3 all clamped together with nuts 5 and bolts 4 in order to create appropriate chambers in accordance with aspects of the present invention. Within the housing, slide blocks 6 and permanent magnets 7 are arranged in location to act upon a passage in order to regulate movement of or displacement of an MR fluid within an essentially closed chamber. In such circumstances an outlet 20 of each middle block 6 presents an engagement element or member in the form of a pin 9. At the other end of the chamber which extends through the middle block 2 push pins or elements 11 are utilised. In such circumstances the chamber which extends through the middle block 2 contains the MR fluid. The MR fluid is displaced to cause movement of the members 9. In such circumstances ends of the engagement elements 9 will engage a component dependent upon the profile of that component. In such circumstances each element 9 will move differentially to engage certain opposed parts of the component surface. The pressurisation of the MR fluid will be retained by the push pin 11. However, more importantly in accordance with aspects of the present invention the magnet 7 will act across and about the passage which extends between parts of the chamber for each engagement element in order to constrain movement of the MR fluid. In such circumstances whilst displaced into engagement the MR fluid will be constrained by the action across the passage of the permanent magnets and therefore the position of the engagement element substantially retained.

As illustrated the arrangement 100a is formed from an assembly of blocks for generally ease of manufacture. In such circumstances it will be understood that typically the MR fluid will be retained through use of appropriate seals such as an O ring seal 10 for each engagement element 9 within the outlet 20 of the chamber. Essentially the chambers in such circumstances are closed with pressurisation achieved by mechanical displacement of the pin 11 or otherwise until there is appropriate engagement by an end of the engagement element 9 against a component. The pressurisation mechanism which may comprise a screw thread displacement or another actuator may retain pressurisation of the MR fluid but in accordance with aspects of the present invention it is generally the solidification in the MR fluid created by the magnets 7 against the reduced volume within the passage defining separation between an engagement end portion of the chamber and a reservoir portion of the chamber in the blocks which has a locking effect.

It will be understood by the passage comprising a narrowing within the chamber there is a reduced volume of MR fluid acted upon by the magnet 7 when inserted. In such circumstances generally simple permanent magnets may be utilised in relation to magnet 7 with efficient and more focussed effects on the reduced volume of MR fluid in the passage. The pins 11 in such circumstances may act to overcome part solidification of the MR fluid within the passage if the magnets are not fully removed in order to cause displacement of the MR fluid for movement of the engagement elements 9. It will be understood part removal of the magnet 7 will reduce the strength of the magnetic field and so rheologic (MR) effects in the passage. In such circumstances the pins 11 would create an over pressure for adjustment by movement of the engagement elements 9 in use. Such an approach may not be overly efficient and in such circumstances it may be necessary to provide for full slide displacement of the magnets 7 during initial adjustment through movement of the MR fluid and then repositioning of the magnets 7 in use to act as a “lock” in terms of action upon the MR fluid within the passage in order to prevent return of the MR fluid back to the reservoir portion of the chamber in order to retain position of the engagement elements 9 in use.

As illustrated in FIG. 1 and FIG. 2 arrangements 100 in accordance with aspects of the present invention generally comprise a plurality of individual engagement elements 9 arranged spatially in order to create contacts through ends of the elements 9 with a component in use. The number of elements 9 used in an arrangement will depend upon operational requirements. Furthermore, it will be understood that the spacing of the ends in particular the engagement members or elements 9 will be a significant factor with regard to the acceptability of the arrangement for supporting and presenting a component in use. The ends will typically be rounded. The ends may be integral with the component or be created by end caps separately attachable dependent upon particular components to be engaged by the arrangement in use. In order to further facilitate spread of load a membrane may be presented to spread across the ends of the engagement members 9 in order to smooth load application against the profile of the component.

Although the engagement elements 9 are shown as cylindrical elements it will be understood that other shapes can also be utilised and provision of square cross section shapes may allow closer association and load distribution in use.

In FIG. 2 it will be noted that there are two side blocks 3 located at each end with six sliding blocks 6 between them to accommodate three permanent magnets each of which can be displaceable in use into a position to act across the passage restricting MR fluid flow utilising a sliding bar 8.

FIG. 3 provides a schematic cross section of the arrangement as depicted in FIG. 2. Thus, a component 103 is engaged by engagement members 9 in respective arrangements 100a, 100b. In such circumstances the arrangements 100 are in opposed positions and therefore clamp the component 103 between. Each element 9 is relatively displaced in its respective chamber by a plunger action by a plunger 11. The plunger 11 will displace a rheological (MR) fluid 50 in order to bring an end of the engagement element 9 into engagement with the component 103. As previously, side blocks 3 are provided within each respective arrangement 100 with middle blocks 2 defining outlets 20 through which the engagement members or elements 9 extend. Displacement of the MR fluid 50 in such circumstances causes movement of the engagement elements 9.

During initial set up ends of the elements 9 will engage the component 103 by mechanical pressurisation of the fluid 50. Positioning of the fluid 50 is retained through the magnetic elements 7 acting across passages 30 created in the chambers at an intermediate position. The passages 30 as indicated above are located between a reservoir section 31 and an engagement section 32 of each respective chamber. Clearly, when not subjected to a magnetic force, displacement of the plunger 11, in the form of typically a pin, will cause movement and flow of the fluid 50. Thus, there will be varying volumes of MR fluid either side of the passage 30. Nevertheless, the amount of MR fluid in the passage 30 will generally be consistent and of a small volume. In such circumstances typically each permanent magnet 7 can act upon the fluid 50 within the passage 30 in order to create a relatively robust resistance to fluid flow across the passage 30. In such circumstances positioning of the engagement elements 9 can be retained by the action of a respective magnet 7 upon the MR fluid 50 within each passage 30.

As indicated above MR fluid 50 under the influence of a magnetic field will “solidify” and therefore the solidified MR fluid 50 within the passage 30 will plug the chamber. In such circumstances the volume of MR fluid 50a in the chamber between the passage 30 and a rearmost part of the engagement element 9 will be substantially retained in order to present that element 9 in use. The volume 50a will not be solidified for the most part by the effects of the magnetic field from the magnets 7 at least to a significant extent. In such circumstances this fluid 50a outside of the passage 30 may still be relatively fluid. There may be a degree of retained fluidity. In order to retain the fluid 50a in such circumstances appropriate seals typically in the form of O ring seals 51 will be presented upon an end of the engagement elements 9 in an array.

In order to present the engagement elements 9 it will be understood that it is desirable to constrain and guide movement. In such circumstances typically an end plate 14 will be provided. This end plate 14 will define and extend the outlet 20 such that by appropriate engagement upon shoulder portions of the engagement elements 9 guiding into a substantially lateral or axial motion under the displacement of the MR fluid 50 can be achieved. In such circumstances and through provision of a relatively stiff and rigid engagement element 9 planar engagement upon the component 10 can be achieved at the respective points of contact by the variously displaced and spaced engagement elements 9.

As indicated above the engagement elements 9 typically include ends which, may be integral or separately attachable which have an appropriate shaping for the expected component 103 profile. As illustrated this end shaping is typically in the form of a dome with an angle of curvature appropriate for the curvature of a component surface to be engaged. Alternative shapings for ends of the engagement elements may include pyramid or peaked as well as provision of flexible end portions to engage the surface sympathetically. As also indicated a membrane may be presented in secure association with ends of the displaceable engagement elements 9 or as a separate mat laid upon these elements to again spread loading and contact point severity upon the component where that component may be damaged by over pressures.

Aspects of the present invention limit the volume of MR fluid which is acted upon by the magnets 7 and therefore as indicated typically only normal permanent magnets are required to retain MR fluid 50 position by solidifying the MR fluid within the passage 30. It is the engagement portion of the chamber between the passage 30 and a rearmost part of the engagement element 9 which will define the retention strength of the arrangement 100 in use. It will be understood the fluid 50a is still fluid and therefore may be compressible under excessive loads but this may add a vibration damping effects. Nevertheless, to further increase loading upon the component 103 the respective arrangements 100a, 100b may be located upon base elements which may themselves be moved mechanically inward or outwardly in order to create greater engagement by the elements 9 upon the component 103.

In use as indicated the chamber is generally closed in order that the MR fluid can be appropriately acted upon. It will be understood that avoidance of air bubbles etc within the MR fluid 50 within the chamber is desirable. Air bubbles or other gases will be compressible and therefore may alter the effective operation of the arrangement in terms of creating an engagement pressure by the engagement elements 9 upon the component 103. In such circumstances typically, each chamber will be filled and a seal or plug 13 provided to retain a closed nature. A vent may be provided which is normally closed with a weighted cap which is lifted by initial pressurisation of the MR fluid. The chamber may include a vent hole for air release in any event.

The actuator in the form of a displaceable pin 11 may be associated with a rear plate 114 of the arrangement 100. In such circumstances the actuator presented by the plunger or pin 11 can retain the MR fluid within the chamber which in turn will retain position of the engagement elements or members 9. The strength of the magnets 7 in such circumstances in order to appropriately block the passages 30 may be diminished in view of the necessity only to retain the volume of fluid on the engagement side of the chamber, including the volume of MR fluid 50a, to retain position of the engagement member 9 in use.

In addition to ratchet or screw thread retention of the means for forced displacement of the MR fluid it will also be understood that mechanical locks may be provided for all or individual actuators in the form of pins or plungers 11 and/or for each engagement element 9.

It will be appreciated that assembly of the arrangements is important in order to ensure avoidance of air bubbles or contamination with water which may affect the operation of the MR fluid in use. In such circumstances assembly will involve initially thoroughly cleaning and drying the apparatus to avoid water contamination. The plungers or push pins and engagement elements will then be loaded within the arrangement with appropriate seals to ensure and avoid MR fluid leakage subsequently. It will be understood that the middle blocks which define the chambers themselves will be well cleaned and filled with an appropriate magnetorheological fluid (MR fluid). As indicated in order to achieve the maximum clamping force generally the MR fluid will be loaded to ensure that the system is substantially air free. One approach with regard to avoiding air contamination would be to proceed as follows:
a) close a vent hole (not shown) at one end of the chamber in the middle block 2, fill from the other side of the hole until the chamber is full, insert a clamp pin (engagement element) 9 and push slowly until the rheological fluid reaches the other end of the middle block, fill the second section of the chamber with MR fluid 50 until the chamber is completely full;
b) support the arrangement and insert the plunger or push pin 11 (actuator) until the MR fluid 50 flows out of a vent hole at the other end, that is to say the chamber is bled in order to ensure that it is full;
c) close the vent hole.

By repeating the above process for each chamber it will be understood that air locks can be avoided. Once the MR fluid 50 is located within the chambers it will be understood other components can then be positioned and clamped in position.

The embodiments described above are given by way of example. Alternatively embodiments are described below with regard to FIGS. 4 to 8.

FIG. 4 illustrates a second embodiment of aspects of the present invention which is similar in operation to that described above with regard to FIGS. 1 to 3. As previously actuators in the form of push pins 211 act within respective arrangements 200a, 200b secured to a base 202. Sleeves 212 are defined to connect parts of the arrangements 200a, 200b with the plungers or actuators in the form of displacement pins 211 at one end of each chamber (not shown) with engagement elements 209 at the other end to allow relative lateral or axial displacement between the elements 209 of the arrangements 200a, 200b in the direction of arrowheads A. As previously the chambers for each substantially aligned actuator or plunger 211 creates MR fluid displacement or movement within the chamber (not shown) with consequent displacement of an engagement element 209. A passage (not shown) but generally part of each sleeve 212 is associated with a magnet. In such circumstances initial displacement of the respective engagement elements 209 is achieved through movement of the plungers or pins 211 and then position retained by the effect of the magnets upon the MR fluid within the passage of the chambers defined by the sleeves 212.

FIG. 5 and FIG. 6 illustrate a third embodiment of the present invention. The process of operation is similar to that described previously in that the principle of operation relates to initially pressurising an MR fluid 350 to cause displacement of engagement elements 309 into engagement with a work piece or component 303.

Passages are defined for chambers and by application of a magnetic force to the MR fluid 350 within the passage retention of position for the engagement members or elements achieved. In the third embodiment push pins or plungers 309 for groups of passages with associated engagement portions of the chambers and engagement elements are utilised. Thus, rather than a single push pin or actuator plunger as with previous arrangements for each individual chamber, a group of chambers are configured in order to initially position the engagement elements and then the magnetic elements act to solidify the MR fluid within the passages and so retain fluid volumes within the engagement portions of the chambers and therefore the displaced position of each engagement element against the component 303.

FIG. 6 provides a cross section of two engagement arrangements 300a, 300b in accordance with a third aspect of the present invention. Thus, each arrangement 300 as indicated presents engagement elements 309 to engage a component 303. The arrangements 300a, 300b are in opposed positions and typically will be secured upon a base. Middle blocks 302 define a chamber within which an MR fluid 350 is located. Each chamber is filled as described previously to avoid air bubbles and in such circumstances generally include plugs 313 to allow entry of the fluid 350 into the arrangements 300. In accordance with a third embodiment as depicted in FIG. 6 and FIG. 5 a combined initial reservoir chamber incorporating MR fluid 350b extends to respective passages 330 for each engagement element 309. Each passage in such circumstances has the reservoir portion of the chamber on one side and an engagement portion incorporating MR fluid 350 on the other. It is by displacement and so increasing the volume of the MR fluid in the engagement portion that each engagement element 309 is displaced into engagement with an opposed part of the component 303.

Displacement of the MR fluid is achieved through a pin or plunger 311 which positively displaces the MR fluid through the passages 330 to alter the volume of MR fluid in the engagement portion. Once the engagement elements 309 are in engagement with the component 303 it will be understood that the magnets 307 will retain the fluid volume in the engagement portion including the MR fluid 350a so retaining position for the engagement elements 309. The benefit of the arrangement as depicted in FIG. 6 is that a single actuator 311 can be utilised in order to force displacement of the fluid 350 and therefore unitary adjustment of all the elements 309 in use. However in accordance with aspects of the present invention as the magnets 307 are directly associated about the passages 330 the effectiveness of the magnetic fields created by the magnets 307 act substantially upon the reduced volume of MR fluid in the passages and therefore create an effective ‘plug’ retaining MR fluid volume 350a and so position for the engagement element 309 in use without the requirement for powerful big magnets.

It will be noted as previously it is important that the MR fluid is retained in a closed chamber. In such circumstances typically the actuator 311 in the form of a pin will include appropriate seals such as O ring seals 310 located within the sleeves created within the blocks 302 to ensure the MR fluid remains within the arrangement 300. It will be noted as previously generally front plates 314 are provided to achieve engagement with side portions of the engagement element 309 for guiding and presentation axially towards the component 303. Backer plates will be utilised in order to define the reservoir containing the MR fluid displaceable through the passage 330 into the engagement portion of the chamber to retain positioning of each engagement element 309 in use.

FIG. 7 and FIG. 8 illustrate a fourth embodiment of aspects of the present invention which can be considered as a variant of the third embodiment as depicted in FIG. 5 and FIG. 6. Rather than a rear surface lateral plunger motion being utilised in the embodiment depicted in FIGS. 7 and 8 a back surface axial movement is used. In such circumstances as previously two arrangements 400a, 400b are presented in an opposed relationship with a component 403 retained between engagement elements 409. In terms of operation as previously the arrangements 400 will typically be presented upon a base 402 which may include means 440 for relative displacement of the arrangements 400a, 400b and therefore increased locating pressure between the elements 409.

In terms of use, the fourth embodiment as depicted in FIG. 7 and FIG. 8, as previously defines chambers including MR fluid 450 in each arrangement 400. In a reservoir portion of the chamber a MR fluid 450b is presented whilst on the other side of passages 430 an engagement portion in each chamber is filled with MR fluid 450a in association with and to cause displacement of engagement elements 409 in use. In such circumstances an actuator typically in the form of a cap 411 is displaced in the direction of arrowhead B to increase or decrease the volume the MR fluid 450 in each engagement portion. The fluid 450 is forced through the passages 430 to cause displacement of the respective elements 409. These elements 409 will then engage surface portions of the component 403. Magnets 407 will then act upon the reduced volume of MR fluid in the passages 430 in order to retain the volumes of MR fluid 450a in the engagement portions of the chambers and so position for the elements 409. As described previously the actuator 411 may retain its position through an engagement with other parts of a housing 450 which defines an aperture to the chamber defined within the housing 450. Typically a bleed hole 413 will also be provided to ensure that the MR fluid is located within the housing 450 without any air bubbles in the chamber to reduce contamination problems and so generally enhance the reliability of clamping force achievable by the arrangements 400. As previously front plates 414 will act as guides for the elements 409.

Generally, the magnets 407 as described previously will be supported upon slide blocks 406 which may be moved into or out of the housing 450 in order that the magnets 407 presented upon the slide blocks 406 engage about the passages 430 to restrain movement of the MR fluid once positioning of the elements 409 is achieved. As described previously with regard to FIG. 2 the magnets 407 will be located upon the slide blocks in an appropriate north south orientation to define magnetic fields across the passages 403 to create the necessary “solidification” in the MR fluid to effectively block flow in the passage 430 and therefore retain MR fluid volumes 450a in the engagement portions of the chambers defined in accordance with aspects of the present invention.

As indicated above it is possible to provide essentially a reservoir of MR fluid upon which a permanent magnet acts at various portions in order to provide rheological effects. In such circumstances the magnet will then only act upon the passage portions of the MR fluid to resist exchange across the passage and so maintain engagement element position.

As indicated above magnets in accordance with aspects of the present invention have particular effect with regard to the reduced volumes of MR fluid in each passage. The smaller volumes of MR fluid allow generally less powerful permanent magnets to be used for operation. The permanent magnets are slid into position. In such circumstances the particular shape of the passage can be important with regard to the efficiency of the effect on the MR fluid.

The efficiency of the magnetic effect on the MR fluid can be evaluated in terms of its yield strength which measures the strength of the structure formed upon application of the magnetic field. In a given arrangement the yield strength depends upon the material contents of the MR fluid, the strength of the magnetic field and the design of the passage. For a given design as illustrated in FIG. 9 the maximum yield strength comes from magnetic pole interaction force and the friction force in the active fluid volume region.

FIG. 9 provides in figures a to e variations with regard to passage shape.

FIG. 9a illustrates a simple normal hole about which the magnetic field applied will act. In such circumstances configurational effects do not affect the magnetic field created but the volume of material is reduced compared to the rest of the chamber so increasing the yield strength concentration across the passage in comparison with the bulk of the chamber.

FIG. 9b illustrates tapering such that it will be appreciated dependent upon the direction of the taper greater yield stress can be created as required by the orientation and presentation of the magnetic field. Similarly with regard to FIG. 9c, FIG. 9d and FIG. 9e changes in the cross sectional shape including as illustrated in FIG. 9c a bend, FIG. 9d a step and FIG. 9e a threaded hole can alter their yield strength and therefore the effectiveness of the magnetic field in regulating MR fluid flow across the passage and therefore retention of position for the engagement element presented upon MR fluid within the engagement portion of the chamber. In such circumstances increasing the yield strength of the MR fluid has been achieved. Essentially the active fluid volume is changed in the passages as depicted in FIG. 9.

It will be understood that by provision of passages and arrangements as above typically in an opposed configuration that a number of components can be supported. Components may vary in three dimensions. In such circumstances simple opposed rows of engagement elements may be insufficient. Thus as described above with regard to earlier embodiments typically engagement elements will be presented in a matrix which extends in columns and rows to provide vertical as well as horizontal engagement points with the component. In such circumstances MR fluid can be presented in a number of ways as described previously principally from a rearward reservoir section through a passage horizontally to the engagement element where an engagement portion of a chamber retains a volume of MR fluid for presentation of the engagement element. A further alternative as illustrated in FIGS. 10 and 11 is to present a vertical column of MR fluid between magnetic elements. In such circumstances the vertical column of MR fluid will be acted upon by the magnetic elements and so this vertical column will be the passage in accordance with aspects of the present invention.

An engagement assembly 1000 as depicted in FIG. 10 and FIG. 11 comprises a number of magnetic elements 1007 located within a chamber housing 1006. MR fluid 1050 is presented within the assembly 1000 and in particular arrangements 1000a, 1000b through an aperture 1013 in an input port 1011 to the arrangements 1000a, 1000b. The MR fluid 1050 extends upwards in a column between the magnetic elements 1007 into chamber portions behind engagement elements 1009. The engagement elements 1009 are presented through a facia plate 1014 towards a component 1003.

The engagement elements 1009 are presented through the facia plate 1014 with seals 1010 provided typically in the form of O rings which ensure retention of the MR fluid within engagement chamber portions of the assemblies 1000a, 1000b.

Upstanding or column portions 1050a of MR fluid in each assembly 1000a, 1000b are associated with magnetic elements 1007 to effectively block and retain volumes of MR fluid within the arrangement 1000a, 1000b. The magnetic elements 1007 are smaller permanent magnets associated with each other in order to create the MR fluid action in accordance with aspects of the present invention. As described previously typically the magnetic elements 1007 are slid into position when required. In such circumstances a component 1003 may be located between the opposed arrangements 1000a, 1000b with MR fluid presented through the inlet 1113 and once positioning has been achieved and therefore the component 1003 retained a plug positioned to prevent further inflow or outflow of MR fluid. The magnetic elements 1007 will then be located in position to effectively stop flow of the MR fluid through the upstanding column portions 1050a and so retain the volume of MR fluid in engagement with the engagement elements 1009 in order to retain the elements 1009 in position typically against a retained component 1003.

In the fifth embodiment as described above with regard to FIG. 10 and FIG. 11 it will be understood that a single input port for the MR fluid is provided and the passages are defined between the magnetic elements 1007 and so closer contact between those elements 1007 and the MR fluid may be achievable. Furthermore, the gap provided between the magnetic elements 1007 effectively defines the passages in accordance with aspects of the present invention and these passages in such circumstances can be made thinner but with a greater depth of association with the magnetic elements 1007 and therefore potentially greater effect upon the MR fluid in use.

Aspects of the present invention particularly relate to utilisation of relatively small permanent magnets in order to create effective engagement arrangements for engaging a component. Initially positioning of the engagement elements which are presented in a matrix within respective arrangements is through pressurisation of the MR fluid. Utilisation of the magnets creates a magnetic field across a reduced volume in each passage and so a blocking effect is achieved. The blocking effect retains positioning and volume of the MR fluid within the engagement portions between each passage and respective rear parts of the pins which define the engagement elements in accordance with aspects of the present invention. With blockage to the passage it will be understood that the constraint upon the engagement element presented upon the MR flow ensures retention of position in use.

As described so far each engagement element is of substantially the same size and configuration in terms of length and end shaping. However, it will also be understood dependent upon expected shaping for a component engagement elements of different size or shape and otherwise can be used in a particular assembly. However, this is potentially contrary to the objective of providing a general modular engagement arrangement which can be broadly utilised with little adaptation. It will also be understood that as described above each chamber and in particular each engagement portion of the chambers defined is substantially as illustrated of the same volume. In some circumstances it may be advantageous to provide differing volumes in different parts of the arrangements. For example outer or more peripheral engagement portions may have a larger or smaller size in terms of fluid volume for engagement by the engagement element. It will be understood that if the engagement portion of the chamber is of a larger volume in comparison with other engagement portions then generally a more progressive or less forceful movement of the engagement element may be achieved or vice versa.

Typically as illustrated the passages are substantially straight from the reservoir portion of the chamber to the engagement portion of the chamber. However, passages which are bent or of variable cross section may be used. Furthermore, it is possible that the passages may taper from one end to the other in order to concentrate the effect of the magnetic field in terms of creating a blockage across the passage in use.

Generally, the engagement elements in accordance with aspects of the present invention will be solid and rigid.

As described above it is possible that the engagement elements may include an auxiliary mechanical lock in addition to the positional retention achieved by utilisation of a magnetic field upon MR fluid in the passages in accordance with aspects of the present invention. The auxiliary lock would act after initial positioning using MR fluid flow and blocking across the passage with a magnetic field.

As indicated above and described engagement arrangements in accordance with aspects of the present invention may be particularly utilised in order to provide clamps or vice like retention of a component in use. Alternatively, components may be simply presented and supported upon the engagement elements in accordance with aspects of the present invention with the weight of a component under gravity retaining position. In such circumstances the end portions of the engagement elements will engage parts of the component over its whole surface and therefore reduce the possibility of distortion in use. Initially the component may be presented in a vertical state with the engagement elements engaging the surface and then the whole assembly turned to a horizontal state with the component then resting upon the end portions of each engagement element.

The number of engagement elements utilised in accordance with aspects of the present invention will depend upon operational requirements and capability with respect to creating sufficiently robust engagement. The elements will be in close association both spatially and mechanicalistically to define individual engagement portions which have a sufficient volume to define engagement element position. Such position can then be retained by blockage of flow of MR fluid through the passage by a magnetic field. Clearly, a greater number of engagement elements will generally mean a greater number of contact points with the component to be retained and therefore support. It will also be understood in such an arrangement the passages may be narrower and therefore weaker magnetic forces and fields may be required to effectively block MR fluid flow through the passage when required.

As indicated above in principle by limiting the volume as well as dimensions of the passage acted upon by the magnet elements in accordance with aspects of the present invention more efficient operation is achieved. Furthermore, in order to improve performance it will be understood that the size and dimensions of the orifice and shaping of the passage could be adjusted. As indicated above with regard to FIG. 9 and elsewhere the passage can be of variable geometry and may taper from one end to the other dependent upon requirements.

Clearly, introduction of the MR fluid into arrangements and assemblies in accordance with aspects of the present invention is important. It is important that the MR fluid is substantially free of compressible bubbles such as air or other gas voids and in such circumstances care must be taken with bleeding of the arrangement particularly with regard to the passage to avoid and removes retention of gas bubbles within that passage. It will be appreciated that gas bubbles would be compressible and therefore reduce the strength of the blocking action created in accordance with aspects of the present invention by a magnetic field. In addition to shaping of the passage other parts of the arrangements may be configured to control MR fluid flow and magnetic field action. Such parts include chambers within which MR fluid is retained. It will also be understood that care must be taken with regard to the filling sequence to utilise gravity and buoyancy of gas bubbles to ensure that they are not retained within the MR fluid.

It will also be understood that as indicated components come in a number of shapes and sizes. In such circumstances assemblies and arrangements in accordance with aspects of the present invention will be designed such that they can be combined in a modular fashion to create larger engagement arrangements and assemblies for different sized components as required. The embodiments of the invention as described above are particularly suitable for such modularity.

As indicated above aspects of the present invention achieve better control with regard to a reconfigurable engagement arrangement by limiting the volume of MR fluid which is acted upon by the magnetic field. In such circumstances smaller permanent magnets can be used more conveniently. However, a factor with regard to such situations is that the response characteristics of the MR fluid should remain consistent or at least remain above an acceptable level. It will be understood with prior arrangements, where relatively massive electromagnetic fields are utilised, degradation in the MR fluid may be more readily accommodated. With closed chambers and volumes of MR fluid in accordance with aspects of the present invention greater care must be taken with regard to the MR fluid in retaining its rheological capabilities. The MR fluid may be retained in a bladder or blister to prevent air or water contamination. The bladder or blister may fill all of the cavity or sit in the passage with other fluids or fluidic association filling the remainder of the cavity.

Further in accordance with second aspects of the present invention there is described a MR fluid which is more appropriate to aspects of the present invention as described above with regard to an engagement arrangement. It will be understood that the MR fluid will typically achieve its magnetorheological function through dispersed carbonyl iron particles within a fluid matrix. These carbonyl iron particles must remain in suspension and so maintain a substantially homogenic nature for as long as possible. If the particles should precipitate out of suspension as a sediment then clearly the operation of the MR fluid will degrade. If such sedimentation occurs within the passage then again physical particle build up blockage may result limiting operational performance in comparison with prior arrangements.

In accordance with second aspects of the present invention an MR fluid is provided which is achieved through synthesis of a polymer matrix—hydrocarbon mixture. Generally polystyrene with a density in the range in the order of 1050 Kg/cm³ is dispersed in an appropriate volume of chloroform utilising a magnetic stirring process. Similarly, a specific volume of dodecanic acid is dispersed in an appropriate amount of chloroform under magnetic stirring. Both solutions are then stirred well together until the polystyrene and dodecanic acid are completely dissolved in the chloroform. Once such dissolution has occurred both solutions are transferred into a single beaker under a continuous magnetic stirring process. Sodium hydroxide is then dissolved in water and dispersed in a drop by drop or suitable other progressive process under continuous magnetic stirring. Typically after a period of time such as two minutes the magnetic stir is replaced by a mechanical stirrer and the mixture stirred well at 2000 rpm in order to form an appropriate matrix. Finally a desired amount of hydrocarbon oil having a viscosity in the range 1 to 10,000 and typically 75 centipoise and a density in the range 0.1 to 5 with typically a preferred density in the order 0.6 to 0.9 g/cm³ is added to the matrix under continuous mechanical stirring to complete synthesis of an appropriate matrix/hydrocarbon oil mixture. Once that matrix mixture is created the mixture is heated typically to in the order of 60° C. for a period of time typically in the order of 48 hours to evaporate the chloroform.

By the above process an appropriate matrix is achieved which can then be utilised in order to achieve a desired MR fluid for a particular application. Normally, MR fluids are created by dispersing carbonyl-iron or other magnetically inducible particles of a known size and density within the matrix. Typically in accordance with aspects of the present invention these carbonyl-iron particles will have a size in the order of 1 to 1,000 μm eg 3 μm and a density in the range 1 to 10 g/cm³ and typically in the order of 7.9 g/cm³. By appropriate stirring a homogeneous mixture is achieved. Typically this stirring will occur at 2,000 rpm for in the order of 5 minutes. Once prepared the MR fluid can then be utilised in engagement arrangements as described above.

Although advantageous, custom made MR fluids for utilisation in engagement arrangements in accordance with aspects of the present invention are generally not required. Magnetorheological fluids synthesised in a number of ways can be used in engagement arrangements. Conversely it will be understood that providing custom made MR fluids may allow more consistent operation with greater stability in use. The MR fluid described above can be used in a number of applications in addition to the engagement arrangement described. For example, the MR fluid may be utilised in a vibration damper due to its very low sedimentation rate and therefore low degradation in use. It will be understood that MR fluids have applications in a number of situations including shock absorbers and damping devices as well as clutches, brakes, actuators and artificial joints. It will be understood that MR devices in such circumstances generally have advantages in terms of faster responses, improved performance and simplicity of design as well as typically a reduced cost.

Magnetorheological fluids utilised in engagement arrangements in accordance with aspects of the present invention may be based upon ferro-magnetic or para-magnetic particles dispersed in an appropriate fluid carrier matrix. Suitable magnetically inducible particles include iron, iron alloys, cobalt, nickel, vanadium, iron oxides, cobalt and cobalt alloys, nickel and nickel alloys, carbonyl iron, iron carbide, iron nitride and any other suitable material.

The size of the particles used in the MR fluid and their volume fraction in the total MR fluid dispersion as will be understood plays a significant role in the properties of the magnetorheological fluid. The size of the particles should be selected such that the particles exhibit multiple magnetic domain characteristics when subjected to applied magnetic fields. In general particles with diameters greater than 0.1μ and less than or equal to 1,000μ can be used. However, particles with diameters greater than 10μ but less than 100μ are preferred. A typically MR fluid consists of 5 to 50% magnetic particles by volume.

It is important that the matrix defined by the carrier fluid for the MR fluid is suitable. Generally, organic liquids especially non-polar organic liquids are used. Most common carrier fluids are suitable and include, but are not limited to, silicon oils, mineral oils, paraffin oils, hydrocarbon oils, water and silicon copolymers. Viscosity is one of the most important properties of the oils in the MR fluid. In such circumstances fluid with viscosities greater than 1 centipoise and less than 100,000 centipoise can be used however, fluid with viscosities greater than 250 centipoise and less than 1,000 centipoise are generally preferred.

In order to extend the suitability generally several additives or stabilising agents will be added to the MR fluid. These additives will offer resistance to sedimentation of the relatively dense magnetic particles in the matrix suspension the additives may also impart improved durability and corrosion resistance in use. MR fluids in accordance with aspects of the present invention can utilise most common additives including dispersants, corrosion inhibitors, antioxidants, carboxylate soaps and thixotropic agents.

Aspects of the present invention provide a modular arrangement for a variety of product types and potential advantages by reducing design, engineering, manufacturing and purchasing requirements with regard to different engagement arrangements with different components. Furthermore, clamping force can be tailored to a particular component to be engaged. Aspects of the present invention provide an ability to increase the clamping force upon a component by movement of a clamping base bed.

Alterations and modifications to aspects of the present invention will be understood by persons skilled in the technology. Thus, for example although permanent magnets are described it will be understood in some circumstances small electromagnets could be used.

1. An engagement arrangement for a component, the arrangement comprising a chamber to retain a volume of magneto-rheological fluid and having a displaceable engagement element, a portion of the MR displaceable through a passage in the chamber to move the engagement element, the passage comprising a narrowing of the chamber and having a magnet associated thereabout to act upon the MR fluid within the passage to retain displacement of the MR fluid within the chamber between the engagement member and the passage.

2. An arrangement as claimed in claim 1 wherein the arrangement incorporates a plurality of engagement elements.

3. An arrangement as claimed in claim 1 wherein each engagement element has its own chamber.

4. An arrangement as claimed in claim 1 wherein each chamber allows differential displacement of the MR fluid across the passage.

5. An arrangement as claimed in claim 1 wherein each chamber and/or each of the engagement elements or members are of different sizes.

6. An arrangement as claimed in claim 1 wherein each chamber is closed by a plunger to provide forced displacement of the MR fluid in use.

7. An arrangement as claimed in claim 1 wherein the passage comprises a constriction between an engagement end of the chamber and a reservoir end of the chamber.

8. An arrangement as claimed in claim 1 wherein the magnet is a permanent magnet.

9. An arrangement as claimed in claim 1 wherein the arrangement comprises a housing defining the chamber with an outlet to accommodate the engagement member.

10. An arrangement as claimed in claim 9 wherein the outlet has an effective length to guide movement of the engagement member beyond the chamber.

11. An arrangement as claimed in claim 1 wherein the engagement element or member has a shaped end.

12. An arrangement as claimed in claim 11 wherein the shaped end is integral with an elongate member or is formed by a separable element.

13. An arrangement as claimed in claim 1 wherein the engagement element is suspended upon the MR fluid against a return bias.

14. An arrangement as claimed in claim 13 wherein the return bias is provided by a mechanical spring.

15. An arrangement as claimed in claim 1 wherein the arrangement incorporates a sensor to determine movement of the elongate member and means to record position of the elongate member.

16. An arrangement as claimed in claim 15 wherein recorded positions for each elongate member is used to provide a part profile record of a component presented in use upon the arrangement.

17. An arrangement as claimed in claim 1 wherein ends of the elongate elements are overlaid by a membrane.

18. (canceled)

19. An assembly comprising a plurality of arrangements as claimed in claim 1.

20. An assembly as claimed in claim 19 wherein the arrangements are presented opposite each other to support and/or hold a component in use therebetween.

21. An apparatus as claimed in claim 19 wherein the arrangements are presented upon a base.

22. An apparatus as claimed in claim 21 wherein the base is displaceable to allow each arrangement to move relative to each other in order to provide further support and/hold a component in use.

23. An magneto-rheological (MR) fluid comprising polystyrene combined with dodecanic acid initially in chloroform with NaOH in water along with a hydrocarbon oil, the combination heated to evaporate the chloroform to define a matrix to receive carbonyl-iron or other magnetically inducible particles in suspension.

24. A fluid as claimed in claim 23 wherein the polystyrene is presented in a form with a density substantially 1050 kg m³.

25. A fluid as claimed in claim 23 wherein the hydrocarbon oil has a viscosity in the range 1 to 10,000 and preferably in the order of 75 centipoise with a density in the range 0.1 to 5 and typically preferably in the range 0.6 to 0.9 g/cm³.

26. A fluid as claimed in claim 23 wherein the carbonyl-iron or other magnetically inducible particles have a size in the range from 1 to 1,000 and preferably 3 μm with a density in the range from 1 to 10 g/cm³ and preferably in the order of 7.9 g/cm³.

27. A fluid as claimed in claim 23 wherein the MR fluid has a composition comprising polystyrene 0.1 to 10 wt/%, dodecanic acid 0.1 to 10 wt/%, sodium hydroxide 0.05 to 5 wt/%, hydrocarbon oil 5 to 95 wt/% and carbonyl-iron or other magnetically inducible particles 20 to 90 wt/%.

28. A fluid as claimed in claim 23 wherein the carbonyl iron or other magnetically inducible particles are retained in suspension within the MR fluid.

29. (canceled)

30. A method of making a magneto-rheological fluid comprising combining polystyrene and dodecanic acid initially in chloroform with subsequent addition of sodium hydroxyl in water whilst continuously stirring, combining the stirred combination of polystyrene, dodecanic acid and sodium hydroxide in chloroform and water suspension with a hydrocarbon oil, heating the combination to evaporate the chloroform and mixing the presented matrix with carbonyl-iron or other magnetically inducible particles.

31. A method as claimed in claim 30 wherein the method includes the addition of in the order of 0.1 to 10 wt/% polystyrene, 0.1 to 10 wt/% dodecanic acid, 0.05 to 5% sodium hydroxide in water, 5 to 95% hydrocarbon oil and 20 to 90% carbonyl-iron or other magnetically inducible particles.

32. (canceled)
